(19) United States
(12) Patent Application Publication
(10) Pub. No.: US 2024/0140333 A1
(43) Pub. Date: May 2, 2024

(54) PROTECTOR

(71) Applicant: SUMITOMO WIRING SYSTEMS, LTD., Mie (JP)

(72) Inventor: Koichi YAMAZAKI, Mie (JP)

(21) Appl. No.: 18/280,639

(22) PCT Filed: Feb. 21, 2022
(86) PCT No.: PCT/JP2022/007036

§ 371 Date: Sep. 6, 2023

(30) Foreign Application Priority Data
Mar. 11, 2021 (JP) 2021-039080

(51) Int. Cl. B60R 16/02; H02G 3/04

(52) U.S. Cl. CPC B60R 16/0215; H02G 3/04

(57) ABSTRACT

A protector (3) includes a protector main body (9) through which an electric wire (2) is passed. The protector main body (9) is at least partially disposed in a space (12) between a first article (10) and a second article (12) that face each other. The protector (3) includes a fixing part (21) that is configured to fix the protector main body (9) to the first article (10). The protector (3) includes a suppression part (27) that suppresses inclination of the protector main body (9) with the fixing part (21) serving as a base point.

### TECHNICAL FIELD

The present invention relates to a protector that protects an electric wire.

### BACKGROUND

Conventionally, vehicles are equipped with wire harnesses for electrically connecting in-vehicle electrical components to each other (see Patent Document 1 and the like).

### PRIOR ART DOCUMENT

### Patent Document

Patent Document 1: JP 2012-115022 A

### SUMMARY OF THE INVENTION

### Problems to be Solved

Incidentally, a vehicle is equipped with various components, and thus the wire harness may need to circumvent components in the vehicle. If an upper wall on the circumvention path is low in strength, there are cases where, when the upper wall is subjected to a load, the load also acts on the harness. It is not desirable that the electric wire of the wire harness is repeatedly subjected to such a load from the viewpoint of decreasing the likelihood of damage to the electric wire.

An object of the present disclosure is to provide a protector that can protect the electric wire of a wire harness.

### Means to Solve the Problem

A protector according to an aspect of the present disclosure includes: a hollow protector main body through which an electric wire of a wire harness is passed, the protector main body being at least partially disposed in a space between a first article and a second article that face each other; a fixing part that is configured to fix the protector main body to the first article; and a suppression part that is configured to suppress inclination of the protector main body with the fixing part serving as a base point.

### Effect of the Invention

According to the present disclosure, it is possible to protect an electric wire.

### BRIEF DESCRIPTION OF THE DRAWINGS

FIG. 1 is a perspective view of a protector that is attached to a vehicle.

FIG. 2 is a side view of the protector attached to the vehicle.

FIG. 3 is an exploded perspective view of the protector.

FIG. 4 is a perspective view of a fixing part of the protector.

FIG. 5 is a bottom view of the protector.

FIG. 6 is a perspective view of the protector as seen from the bottom side.

FIG. 7 is a perspective view of the protector as seen from the upper side.

FIG. 8 is an overview of the protector under a load.

FIG. 9A is an overview of a suppression part prior to operating, and FIG. 9B is an overview of the suppression part in operation.

### DETAILED DESCRIPTION TO EXECUTE THE INVENTION

First, embodiments of the present disclosure will be listed and described.

[1] A protector of the present disclosure includes: a hollow protector main body through which an electric wire of a wire harness is passed, the protector main body being at least partially disposed in a space between a first article and a second article that face each other; a fixing part that is configured to fix the protector main body to the first article; and a suppression part that is configured to suppress inclination of the protector main body with the fixing part serving as a base point.

According to this configuration, if the protector is subjected to a load from above, the protector may incline with the fixing part serving as a base point. However, the suppression part provided on the protector can make inclination of the protector unlikely to occur. For example, the protector may incline and cause a tensile force to act on the electric wire of the wire harness at an opening from which the electric wire is drawn out from the protector. In this configuration, however, this situation is unlikely to occur. Accordingly, it is possible to protect the electric wire of the wire harness.

[2] The protector main body has a shape that traverses the columnar first article. According to this configuration, it is possible to effectively use a space around the first article to secure a path for the electric wire of the wire harness.

[3] A plurality of the suppression parts are provided. According to this configuration, if the protector moves to incline due to a load imposed on the protector from above with the fixing part serving as a base point, the load is dispersed by the plurality of suppression parts, and thus it is possible to make the protector unlikely to incline.

[4] The protector main body includes a first electric wire insertion part that is disposed so as to face an upper surface of the columnar first article and a second electric wire insertion part that is disposed so as to face a side surface of the first article. The fixing part is disposed on a bottom surface of the first electric wire insertion part. The suppression parts are disposed on an internal surface of the second electric wire insertion part. According to this configuration, if the protector moves to incline due to a load imposed on the protector from above with the fixing part serving as a base point, it is possible to firmly hold the position of the protector using the suppression parts in abutment with the side surface of the first article.

[5] The first electric wire insertion part includes a pair of arm parts that are disposed in the space. The second electric wire insertion part is formed in a shape so as to couple the pair of arm parts. Each arm part is provided with the fixing part. According to this configuration, even if there is an obstacle at an intermediate point between the pair of arm parts, the electric wire can be made to circumvent the obstacle using the protector and return to the original routing path where circumvention is not required.

[6] Each suppression part has a leading end and a base end, and the base end of the suppression part is configured to warp with the leading end of the suppression part serving as a fulcrum. The suppression part suppresses inclination of the protector main body by using a reaction force of the warping of the base end of the suppression part with the leading end of the suppression part serving as a fulcrum. According to this configuration, each suppression part can be shaped with no member at the leading end of the suppression part. Accordingly, it is possible to make a situation unlikely to occur in which, when the suppression part warps, the leading end of the suppression part interferes with a nearby wall surface or the like.

[7] The suppression parts are spring parts that generate a bending reaction force in accordance with inclination of the protector main body and use the bending reaction force to suppress inclination of the protector main body. According to this configuration, it is possible to suppress the inclination of the protector main body with a simple spring structure.

### Details of Embodiments of Present Disclosure

Specific examples of a protector in the present disclosure will be described below with reference to the drawings. It should be noted that the present invention is not limited to the examples herein, but rather is indicated by the scope of claims, and is intended to include all modifications within a meaning and scope equivalent to the scope of claims. In the drawings, some of the components may be shown in an exaggerated or simplified manner for the convenience of description, and the dimensional ratios of the components may differ from the actual dimensional ratios.

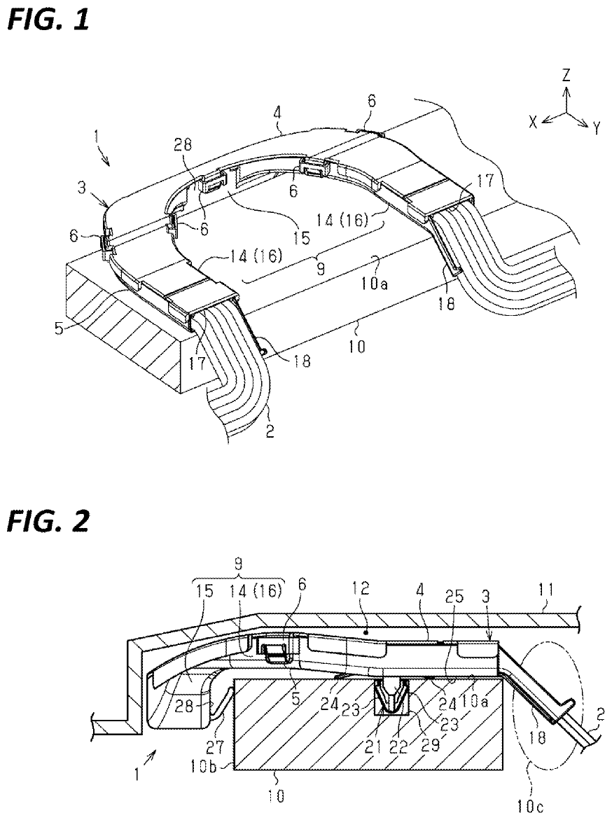

As shown in FIG. 1, a wire harness 1 electrically connects electrical components provided in a vehicle to each other. The electrical components include various ECUs, a motor, an engine, and the like, for example. The wire harness 1 includes an electric wire 2 and a protector 3 that covers and protects a part of the electric wire 2. The electric wire 2 may be one electric wire or a bundle of electric wires.

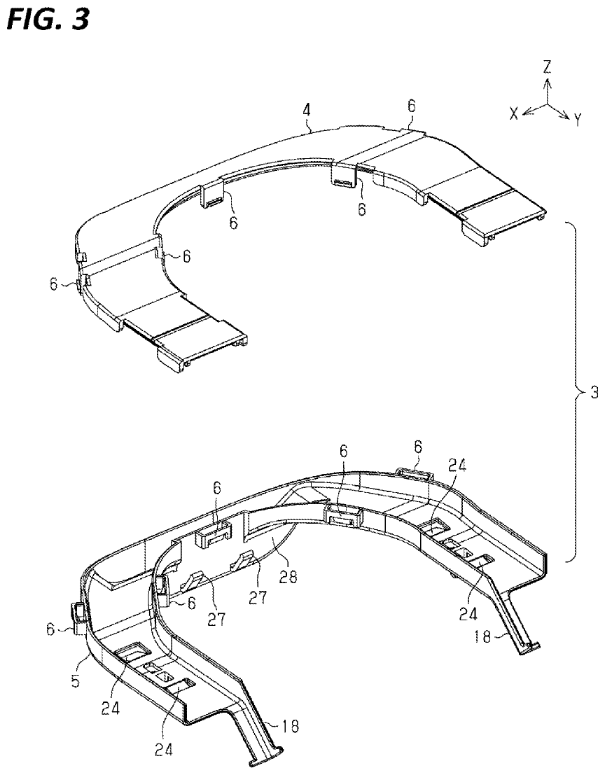

As shown in FIG. 3, the protector 3 is formed by assembling two housings 4 and 5. For example, the two housings 4 and 5 may be an upper housing 4 and a lower housing 5. The two housings 4 and 5 may be assembled and fixed to each other via a plurality of snap-fit parts 6. When the two housings 4 and 5 are assembled, an internal space of the protector 3 is demarcated. The electric wire 2 is accommodated in the internal space.

As shown in FIG. 2, the protector 3 includes a protector main body 9 through which the electric wire 2 is passed. The protector main body 9 is at least partially disposed in a space 12 between a first article 10 and a second article 11 that face each other, for example. The first article 10 may be a cross member that extends in the left-right direction of the vehicle, for example. The second article 11 may be a floor surface (carpet or the like) of the vehicle interior, for example. The space 12 may be a narrow gap between the cross member and the floor surface of the vehicle interior.

As shown in FIG. 1, the protector main body 9 is formed in a shape that traverses the columnar first article 10. For example, the protector main body 9 includes a first electric wire insertion part 14 that is disposed on an upper surface 10a of the columnar first article 10 and a second electric wire insertion part 15 that is disposed so as to face a side surface 10b of the first article 10. For example, the first electric wire insertion part 14 is a pair of arm parts 16 that are disposed in the space 12. The second electric wire insertion part 15 is shaped so as to couple the pair of arm parts 16. In this manner, the protector main body 9 has a shape in which the pair of arm parts 16 are coupled at the bases thereof, that is, in a substantially U shape.

Each of the arm parts 16 has an opening 17 at a leading end thereof for drawing the electric wire 2 into the protector main body 9. Each opening 17 has a guide part 18 that guides the orientation of the electric wire 2 exposed from the opening 17. The guide part 18 may be an elongated guide piece that extends in an oblique direction from a corner of the opening 17, for example.

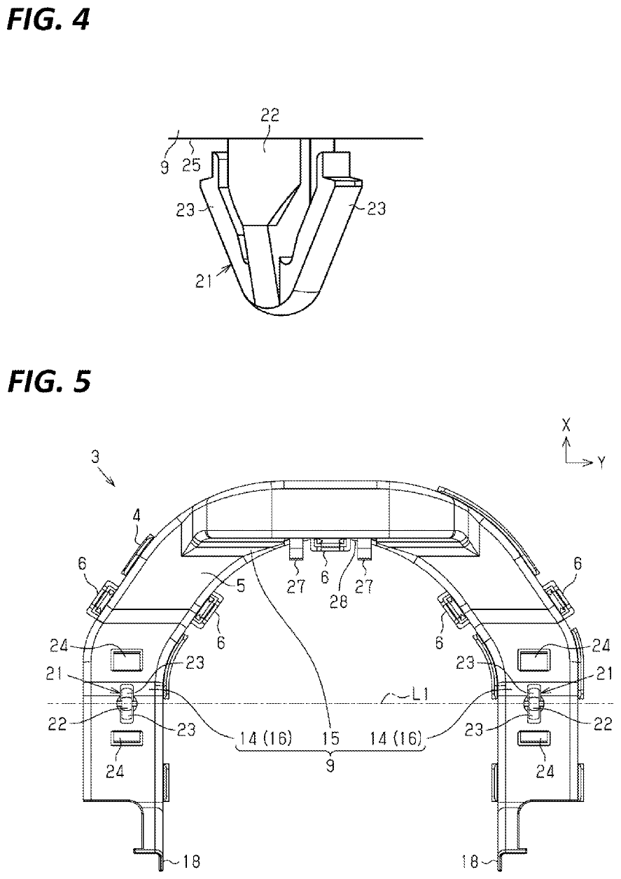

As shown in FIG. 4, the protector 3 includes a fixing part 21 that is configured to fix the protector main body 9 to the first article 10 (cross member). The fixing part 21 is disposed on a bottom surface 25 of the first electric wire insertion part 14 (for example, the arm parts 16). The fixing part 21 is provided at each arm part 16. If two arm parts 16 are provided, two fixing parts 21 are provided on the protector main body 9.

Each fixing part 21 includes a main body 22 and a protruding piece 23 that engages with the first article 10 (cross member). The main body 22 is disposed on the bottom surface 25 of the protector main body 9 (the arm parts 16), and has a rectangular cross section, for example. A plurality of protruding pieces 23 are provided, for example. If two protruding pieces 23 are provided, the protruding pieces 23 are disposed so as to face each other with the main body 22 therebetween. Each protruding piece 23 is coupled to the main body 22 at the base thereof, and is shaped such that its leading end separates from the main body 22 with increasing proximity to the bottom surface of the protector main body 9.

As shown in FIG. 5, a pair of fixing parts 21 are disposed on a shared transverse line L1 that traverses the arm parts 16 and intersects the arm parts 16. The bottom surface 25 of the protector main body 9 (the arm parts 16) has pairs of pressing pieces 24 that are correspondingly provided with a fixing part 21 therebetween and are separated from the fixing part 21. The pressing pieces 24 have a plate spring structure, for example. When attaching the protector 3 to the first article 10, the pressing pieces 24 cooperate with the fixing parts 21 to fix the protector 3 to the first article 10. The fixing parts 21 are disposed on the bottom surface 25 of the first electric wire insertion part 14.

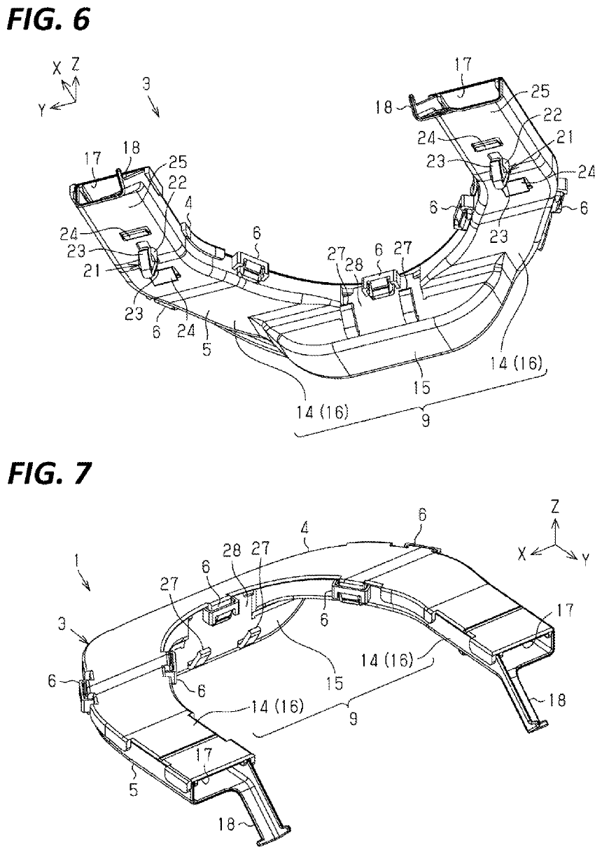

As shown in FIGS. 6 and 7, the protector 3 includes a suppression part 27 that suppresses inclination of the protector main body 9 with the fixing parts 21 serving as base points. There may be more than one suppression part 27, for example, two suppression parts 27. For example, the plurality of suppression parts 27 are arranged in a line in the width direction of the protector main body 9 (the Y-axis direction in FIG. 6 and the like), and are spaced apart from each other. The suppression parts 27 are disposed on an internal surface 28 of the second electric wire insertion part 15. For example, the suppression parts 27 may be spring parts (spring structures) that generate a bending reaction force as the protector main body 9 inclines and use the bending reaction force to suppress inclination of the protector main body 9.

Next, operation of the protector 3 in the present embodiment will be described.

As shown in FIG. 2, if the wire harness 1 is routed along the first article 10, for example, the routing path may be limited due to the presence of an in-vehicle obstacle 10c (see FIG. 2). In this case, the wire harness 1 needs to take a path that circumvents the in-vehicle obstacle 10c. If the circumvention path needs to pass through the space 12 between the first article 10 and the second article 11, the wire harness 1 needs to be protected from impact and the like from the second article 11. Thus, the protector 3 is attached to the first article 10 in the space 12 between the first article 10 and the second article 11, and the wire harness 1 is passed through the protector 3.

For example, the protector 3 is fixed to the first article 10 by attaching, respectively, the fixing parts 21 formed on the bottom surface of the protector main body 9 to recessed parts 29 formed on the upper surface 10a of the first article 10. Each recessed part 29 of the first article 10 may be an elongated hole that corresponds to the shape of the main body 22 of the fixing part 21, for example. With a combination of the shapes of the fixing part 21 and the recessed part 29 having a rectangular cross section and constituting a long hole, this combination is advantageous in firmly fixing the fixing part 21 to the recessed part 29 without the fixing part 21 rotating in the recessed part 29.

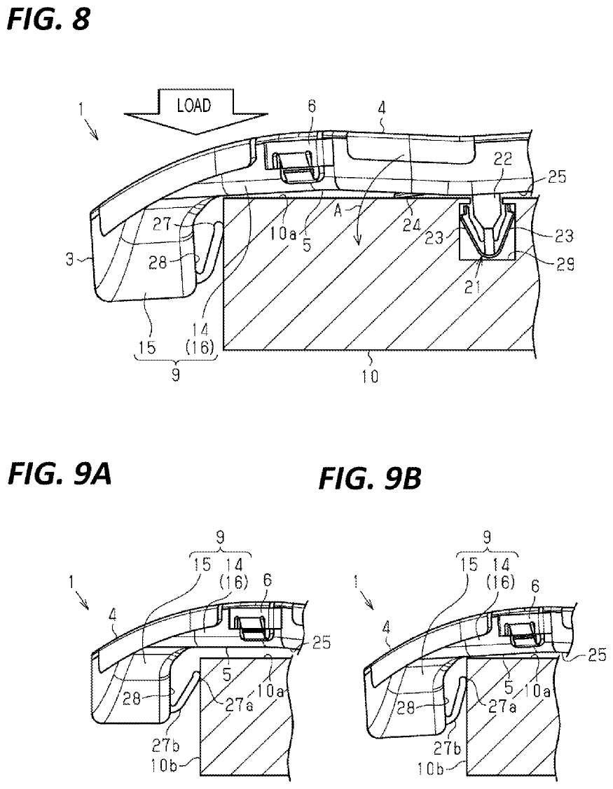

As shown in FIG. 8, if a load is imposed on the upper surface of the second article 11, the load may be transferred to the protector 3 and the protector 3 may incline in a direction indicated by an arrow A in FIG. 8 with the fixing parts 21 serving as base points. For example, if the second article 11 is the floor surface of the vehicle interior, when the floor surface is stepped on, the protector 3 will incline with the fixing parts 21 serving as base points. If the protector 3 is inclined, the electric wire 2 will be pulled upon at the openings 17 of the protector 3, and an excessive load will be imposed on the wire harness 1 near the openings 17. In addition, the bottom surface of the protector main body 9 may come into contact with the first article 10 and this contact may also cause a hammering sound.

On the other hand, in the present embodiment, as shown in FIG. 9A, since the protector 3 is provided with the suppression parts 27, even if a load that causes the protector 3 to incline is imposed on the protector 3 from above, the suppression parts 27 generate a reaction force according to the inclination of the protector 3. The reaction force is advantageous in returning the protector 3 to its original posture (also called “initial position”). Therefore, even if a load is imposed on the protector 3, the protector 3 is likely to be held at the initial position, which makes the problem described above unlikely to occur.

For example, as shown in FIG. 9B, each suppression part 27 may be a cantilever plate spring. A leading end 27a of the suppression part 27 with a spring structure may always be in contact with the side surface 10b of the first article 10. If a load that causes the protector 3 to incline is imposed on the protector 3, a base end 27b of the suppression part 27 may elastically warp with the leading end 27a of the suppression part 27 serving as a fulcrum and generate a reaction force. Since the leading end 27a of the suppression part 27 may be tapered and does not need to have a bulky shape, when the suppression part 27 warps, the leading end 27a of the suppression part 27 does not inadvertently come into contact with the inner surface of the protector 3. The suppression parts 27 having a spring structure are advantageous in that the absorption of a load using elastic deformation of the suppression parts 27 is unlikely to be hindered, and are also advantageous in that a wide space for warping of the suppression parts 27 can be secured.

Each suppression part 27 is a member that is provided on a member (the protector 3) with a tendency to incline under a load, and suppresses the inclination. Providing the suppression parts 27 with a simple structure on the protector 3 makes it possible to suppress inclination of the protector 3. The protector 3 may be formed as one piece with the suppression parts 27, for example, and may be a synthetic resin protector, for example.

According to the protector 3 in the embodiment described above, it is possible to obtain the following advantageous effects.

(1) The protector 3 includes the protector main body 9, the fixing parts 21, and the suppression parts 27. The protector main body 9 is hollow and has an internal space through which the electric wire 2 of the wire harness 1 can be passed. The protector main body 9 is at least partially disposed in the space 12 between the first article 10 and the second article 11 that face each other. The fixing parts 21 fix the protector main body 9 to the first article 10. The suppression parts 27 suppress the inclination of the protector main body 9 with the fixing parts 21 serving as base points.

According to the present embodiment, if the protector 3 is subjected to a load from above, the protector 3 may incline with the fixing parts 21 serving as base points. However, the suppression parts 27 provided on the protector 3 can make inclination of the protector 3 unlikely to occur. If the protector 3 is inclined, the electric wire 2 in the protector 3 may be pulled upon and subjected to a load at the openings 17 through which the electric wire 2 in the protector 3 passes. In the present embodiment, this situation is unlikely to occur. Accordingly, it is possible to protect the electric wire 2.

(2) Since the protector 3 is made unlikely to incline, it is possible to make a situation where the protector 3 becomes inclined and comes into contact with the first article 10 unlikely to occur. Accordingly, it is possible to make a hammering sound made by the protector 3 inclining and coming into contact with the first article 10 unlikely to occur.

(3) The protector main body 9 has a shape that traverses the columnar first article 10. According to this configuration, it is possible to effectively use space around the first article 10 to secure a path for the electric wire 2.

(4) A plurality of the suppression parts 27 are provided. According to this configuration, even if the protector 3 moves to incline with the fixing parts serving as base points due to a load imposed on the protector 3 from above, the load is dispersed by the suppression parts 27, and thus it is possible to make the protector 3 unlikely to incline.

(5) The protector main body 9 includes the first electric wire insertion part 14 that is disposed so as to face the upper surface 10a of the columnar first article 10 and the second electric wire insertion part 15 that is disposed so as to face the side surface 10b of the first article 10. The fixing parts 21 are disposed on the bottom surface 25 of the first electric wire insertion part 14. The suppression parts 27 are disposed on the inner surface 28 of the second electric wire insertion part 15. According to this configuration, even if the protector 3 moves to incline with the fixing parts 21 serving as base points due to a load imposed on the protector 3 from above, it is possible to firmly hold the position of the protector 3 using the suppressions part 27 in abutment with the side surface 10b of the first article 10.

(6) The first electric wire insertion part 14 includes the pair of arm parts 16 that are disposed in the space 12. The second electric wire insertion part 15 is formed in a shape so as to couple the pair of arm parts 16. The fixing parts 21 are respectively disposed on the arm parts 16. According to this configuration, even if the obstacle 10c (see FIG. 2) is located at an intermediate point between the pair of arm parts 16, the electric wire 2 can be made to circumvent the obstacle using the protector 3 and return to the original routing path where circumvention is not required.

(7) The suppression parts 27 suppress inclination of the protector main body 9 using warping of the base ends 27b with the leading ends 27a serving as fulcrums. According to this configuration, each suppression part 27 can be shaped with no member at the leading end 27a of the suppression part 27. Accordingly, it is possible to make a situation unlikely to occur in which, when the suppression parts 27 warp, the leading ends 27a of the suppression parts 27 interfere with a nearby wall surface or the like (for example, the inner surface of the protector 3 and the like).

(8) Each suppression part 27 is a spring part that imposes a load for suppressing inclination to the protector main body 9 by using a bending reaction force. According to this configuration, the suppression parts 27 can be configured with a simple spring structure.

As shown in FIG. 2, the first article 10 can have the upper surface 10a that is an example of a first support surface supporting the protector 1, the side surface 10b that is an example of a second support surface supporting the protector 1, which is different from the first support surface, and a corner part that is formed by the upper surface 10a and the side surface 10b therebetween. The first article 10 is an example of a support body that supports the protector 1. The arm parts 16 of the protector 3 may be referred to as hollow arm parts. The second electric wire insertion part 15 of the protector 3 may be referred to as an intermediate U-shaped bend part that hangs down from the two arm parts 16.

As shown in FIG. 2, each pressing piece 24 may be referred to as a first damper projection capable of elastic deformation, which is provided on the protector main body 9 so as to form a first buffer space between the bottom surface 25 of the protector main body 9 and the upper surface 10a of the first article 10, or is provided on the protector main body 9 so as to support the bottom surface 25 of the protector main body 9 in a state of being distanced from the upper surface 10a of the first article 10, or is configured to elastically come into contact with the upper surface 10a of the first article 10. As shown in FIG. 2, each suppression part 27 may be referred to as a second damper projection capable of elastic deformation, which is provided on the protector main body 9 so as to form a second buffer space between the internal surface 28 of the protector main body 9 and the side surface 10b of the first article 10, or is provided on the protector main body 9 so as to support the internal surface 28 of the protector main body 9 in a state of being distanced from the side surface 10b of the first article 10, or is configured to elastically come into contact with the side surface 10b of the second article 10.

The present embodiment can be modified and implemented as described below. The present embodiment and the following modifications can be combined with each other provided no technical contradiction occurs.
The fixing part 21 may have a structure where a projection provided on the first article 10 is inserted into and fixed to a recessed part provided on the protector 3, for example.
The fixing part 21 is not limited to an insertion clip and may have any shape that is capable of fixing the protector 3 to the first article 10.
The suppression parts 27 are not limited to being disposed on the internal surface 28 of the protector 3, and may be disposed on the bottom surface 25 of the protector main body 9, for example.
The suppression parts 27 may be disposed both on the bottom surface 25 and the internal surface 28 of the protector 3.
The place where the suppression parts 27 are disposed can be freely set as appropriate.
There is no limit to providing a plurality of suppression parts 27, and one suppression part 27 may be provided, for example.
The suppression parts 27 are not limited to being spring parts (plate springs), and may have any shape that is capable of imparting an inclination reaction force to the protector 3.
The shape of the first electric wire insertion part 14 and the second electric wire insertion part 15 is not limited to a shape with a flat cross section, and may be changed to another shape such as a shape with a circular cross section or a shape with a square cross section, for example.
The shape of the protector main body 9 is not limited to a U shape. For example, the shape of the protector main body 9 may be changed to another shape such as an L shape.
The shape of the protector main body 9 may be a shape with only one arm part 16, for example.
The first article 10 is not limited to a cross member, and may be another member such as a vehicle body frame, for example.
The second article 11 is not limited to an in-vehicle floor surface, and may be any member on which a load from a vehicle user is imposed, for example.
The space 12 in which the protector 3 is disposed is not limited to the gap between the first article 10 and the second article 11, and may be any gap between two members of the vehicle.
The housing structure of the protector 3 is not limited to a structure in which the two housings 4 and 5 are assembled. For example, the housing structure may be formed by three or more housing members or may be formed by only one housing member.
The electric wire 2 is not limited to one electric wire and may be an electric wire group in which a plurality of electric wires are bundled. The electric wire 2 may be an electric wire covered with a coating material.
The present disclosure has been described in reference to the examples. However, it is to be understood that the present disclosure is not limited to the examples or structures. The present disclosure also includes various modifications and variations within an equivalent range. In addition, various combinations and modes, and other combinations and modes including only one element or more or less also fall within the scope and conceptual range of the present disclosure.

For example, the present disclosure includes the following embodiments.

(Supplementary Note 1) A protector including: a hollow first arm part through which an electric wire is passed; a hollow second arm part that is disposed so as to face the first arm part and through which the electric wire is passed; and a hollow coupling part that is shaped so as to couple the first arm part and the second arm part and through which the electric wire is passed.

The first arm part and the second arm part correspond to the first electric wire insertion parts, and the coupling part corresponds to the second electric wire insertion part.

The routing path of the wire harness is subject to space limitations in the vehicle. For example, a part of the vehicle body or a vehicle-mounted object may be the obstacle 10c (see FIG. 2) on the routing path of the wire harness. Repositioning of the obstacle 10c requires large-scale design changes to the vehicle. According to the present disclosure, the first arm part, the second arm part, and the coupling part of the protector allow the protector to be disposed so as to surround or circumvent the obstacle 10c. Therefore, it is possible to reduce the need for making design changes to the vehicle. Also, it is possible to improve the flexibility with which the routing path of the wire harness can be changed such that the routing path of the wire harness can circumvent the obstacle 10c.

(Supplementary Note 2) The protector according to Supplementary Note 1 including a fixing part that is fixed to an article. According to Supplementary Note 2, the protector can be fixed by the fixing part to the article so that the protector can be held at a predetermined attachment position.

(Supplementary Note 3) The protector according to Supplementary Note 2, wherein the fixing part is disposed on bottom surfaces of the first arm part and the second arm part. According to Supplementary Note 3, the protector can be firmly fixed to the article by two fixing parts, that is, the fixing part on the bottom surface of the first arm part and the fixing part on the bottom surface of the second arm part.

(Supplementary Note 4) The protector according to Supplementary Notes 1 to 3, wherein the coupling part extends on a plane intersecting a plane on which the first arm part and the second arm part extend. According to Supplementary Note 4, it is possible to dispose the protector along the upper surface 10a and the side surface 10b of the article. Therefore, even if storage space is limited, the protector can be disposed.

(Supplementary Note 5) The protector according to Supplementary Notes 1 to 4, wherein the first arm part and the second arm part are shaped with a rectangular lateral cross section (vertical cross section) such that the first arm part and the second arm part can be disposed in the gap. According to this configuration, the protector can be made thin. Therefore, even if storage space is limited, the protector can be disposed.

(Supplementary Note 6) The protector according to Supplementary Notes 1 to 5, wherein a guide part is provided at each opening of the first arm part and the second arm part to guide the electric wire to pass through the openings. According to this configuration, it is easy to pass the electric wire through the protector using the guide part.

(Supplementary Note 7) An embodiment of the present disclosure is directed to a protector (1) that is used together with a support body (10) and an electric wire (2) of a wire harness (1) to protect a certain-length portion of the electric wire, wherein the protector (1) can include: a hollow protector main body (9) that is fixed in an initial posture to the support body (10) and covers the certain-length portion of the electric wire of the wire harness (1);
a plurality of first damper projections (24) that are elastically deformable and are provided at a plurality of first predetermined positions of the hollow protector main body (9); and
a plurality of second damper projections (27) that are elastically deformable and are provided at a plurality of second predetermined positions of the hollow protector main body (9),
wherein the plurality of first damper projections (24) and the plurality of second damper projections (27) may be configured to, when the hollow protector main body (9) inclines from the initial posture with respect to the support body (10), generate an elastic restoring face to return the hollow protector main body (9) to the initial posture.

(Supplementary Note 8) The hollow protector main body (9) may include: two end portions (17) that each have an electric wire pullout port (17) from which the electric wire (2) is pulled out; two hollow arm parts (16) that respectively extend from the two end portions (17); and an intermediate U-shaped bent part (15) that is positioned between the two hollow arm parts (16) and hangs down from the two hollow arm parts (16), and
the plurality of first damper projections (24) may be integrally formed with the two hollow arm parts (16) of the hollow protector main body (9), and the plurality of second damper projections (27) may be integrally formed with the intermediate U-shaped bent part (15) of the hollow protector main body (9).

(Supplementary Note 9) The plurality of first damper projections (24) may be first plate springs that are cantilever-supported by the two hollow arm parts (16) of the hollow protector main body (9),
and each of the plurality of second damper projections (27) may be a first plate spring that is cantilever-supported by the intermediate U-shaped bent part (15) of the hollow protector main body (9).

(Supplementary Note 10) The support body (10) may have: a first support surface (10a); a second support surface (10b) that is different from the first support surface (10a); and a corner part between the first support surface (10a) and the second support surface (10b), the plurality of first damper projections (24) may be configured to elastically come into contact with the first support surface (10a) of the support body (10) and form a first buffer space between the hollow protector main body (9) and the first support surface (10a), and
the plurality of second damper projections (27) may be configured to elastically come into contact with the second support surface (10b) of the support body (10) and form a second buffer space between the hollow protector main body (9) and the second support surface (10b).

### LIST OF REFERENCE NUMERALS

1 Wire harness
2 Electric wire
3 Protector
4 Housing
5 Housing
6 Snap-fit part
9 Protector main body
10 First article
11 Second article
12 Space
10a Upper surface of first article
10b Side surface of first article
14 First electric wire insertion part
15 Second electric wire insertion part
16 Arm part
17 Opening
18 Guide part
21 Fixing part
22 Main body
23 Protruding piece
24 Pressing piece (first damper projection)
25 Bottom surface
27 Suppression part (spring part, second damper projection)
28 Internal surface
29 Recessed part
L1 Transversal line

1. A protector comprising:
a hollow protector main body through which an electric wire of a wire harness is passed, the protector main body being at least partially disposed in a space between a first article and a second article that face each other;
a fixing part that is configured to fix the protector main body to the first article; and
a suppression part that is configured to suppress inclination of the protector main body with the fixing part serving as a base point.

2. The protector according to claim 1,
wherein the protector main body has a shape that traverses the columnar first article.

3. The protector according to claim 1,
wherein a plurality of the suppression parts are provided.

4. The protector according to claim 1,
wherein the protector main body includes a first electric wire insertion part that is disposed so as to face an upper surface of the columnar first article and a second electric wire insertion part that is arranged so as to face a side surface of the first article,
the fixing part is disposed on a bottom surface of the first electric wire insertion part, and
the suppression part is disposed on an internal surface of the second electric wire insertion part.

5. The protector according to claim 4,
wherein the first electric wire insertion part includes a pair of arm parts that are disposed in the space,
the second electric wire insertion part is formed in a shape so as to couple the pair of arm parts, and
each arm part is provided with the fixing part.

6. The protector according to claim 1,
wherein the suppression part has a leading end and a base end,
the base end of the suppression part is configured to warp with the leading end of the suppression part serving as a fulcrum, and
the suppression part suppresses inclination of the protector main body by using a reaction force of the warping of the base end of the suppression part with the leading end of the suppression part serving as a fulcrum.

7. The protector according to claim 1,
wherein the suppression part is a spring part that generates a bending reaction force in accordance with inclination of the protector main body and uses the bending reaction force to suppress inclination of the protector main body.

8. A protector that is used together with a support body and an electric wire of a wire harness to protect a certain-length portion of the electric wire,
wherein the protector comprises:
a hollow protector main body that is configured to be fixed in an initial posture to the support body and cover the certain-length portion of the electric wire of the wire harness;
a plurality of first damper projections that are elastically deformable and are provided at a plurality of first predetermined positions on the hollow protector main body; and
a plurality of second damper projections that are elastically deformable and are provided at a plurality of second predetermined positions on the hollow protector main body, and
the plurality of first damper projections and the plurality of second damper projections are configured to, when the hollow protector main body becomes inclined from the initial posture with respect to the support body, generate an elastic restoring force to return the hollow protector main body to the initial posture.

9. The protector according to claim 8,
wherein the hollow protector main body includes: two end portions that each have an electric wire pullout port from which the electric wire is pulled out; two hollow arm parts that respectively extend from the two end portions; and an intermediate U-shaped bent part that is positioned between the two hollow arm parts and hangs down from the two hollow arm parts,
the plurality of first damper projections are integrally formed with the two hollow arm parts of the hollow protector main body, and
the plurality of second damper projections are integrally formed with the intermediate U-shaped bent part of the hollow protector main body.

10. The protector according to claim 9,
wherein the plurality of first damper projections are first plate springs that are cantilever-supported by the two hollow arm parts of the hollow protector main body, and
each of the plurality of second damper projections is a first plate spring that is cantilever-supported by the intermediate U-shaped bent part of the hollow protector main body.

11. The protector according to claim 8,
wherein the support body has: a first support surface; a second support surface that is different from the first support surface; and a corner part between the first support surface and the second support surface,
the plurality of first damper projections are configured to elastically come into contact with the first support surface of the support body and form a first buffer space between the hollow protector main body and the first support surface, and
the plurality of second damper projections are configured to elastically come into contact with the second support surface of the support body and form a second buffer space between the hollow protector main body and the second support surface.
